(19) United States
(12) Patent Application Publication
(10) Pub. No.: US 2002/0170595 A1
(43) Pub. Date: Nov. 21, 2002

(54) Earthquake and/or emission detector with utility shut off

(76) Inventor: Jason A. Oliver, Arcadia, IN (US)

Correspondence Address: E. Victor Indiano, Esq., Suite 850, One North Pennsylvania Street, Indianapolis, IN, 46204, US

(21) Appl. No.: 10/122,606

(22) Filed: Apr. 12, 2002

Related U.S. Application Data
(60) Provisional application No. 60/291,567, filed on May 17, 2001.

(51) Int. Cl. G05B 1/00

(52) U.S. Cl. 137/38; 340/689; 340/690; 340/669

(57) ABSTRACT

An earthquake sensor and a control system is provided for sensing the presence of an earthquake event and for shutting off the flow of at least one utility service in response thereto. The earthquake sensor and control system includes a vibration sensor for sensing vibrations caused by an earthquake. A signal generator is provided for generating a utility flow stop signal in response to an earthquake induced vibration sensed by the vibration sensor. A utility flow control is provided for stopping the flow of the utility service in response to receiving the utility flow stop signal.

### I. STATEMENT OF PRIORITY

The instant application claims priority to Jason Allen Oliver, U.S. Provisional Patent Application No. 60/291,567, which was filed on May 17, 2001.

### II. TECHNICAL FIELD OF THE INVENTION

The present invention relates to earthquake detecting devices, and more particularly to a device capable of detecting earthquake induced vibrations, and initiating the shut-off of utility services as a result of these detected vibrations. Additionally, the present invention has the capability of also initiating the shut off of utility services as a result of the detection of fire and emission events.

### III. BACKGROUND OF THE INVENTION

Earthquakes result from geologic forces inducing the movement of underground geologic structures, and manifest themselves in movements of geologic plates and/or structures relative to other plates and structures. The movement of these geologic structures caused by an earthquake produces vibrations that are associated with this geologic movement. Depending upon the severity of the earthquake, and its proximity to a particular location, the earthquake can cause a wide range of disturbances. For example, a small earthquake that is located far from a particular location will often be felt as little more than a slight rumbling of the earth, and may result in no significant damage, or damages as light as causing glasses to clink together in a kitchen cabinet. However, more significant earthquakes can cause significant structural damage to structures as large as bridges, interstate highways, homes and commercial buildings, often turning such structures into mere piles of rubble. The stresses induced on a structure through these earthquake induced movements can cause the structure to break apart, or come crashing down.

The primary impact of an earthquake upon a structure is that the stresses induced on the structure by the movement of the earth can cause strains on the building or structure which cause the structure (or components thereof) to split apart, or to crumble because of the weakening caused to the structure's foundation by the induced strain. However, the secondary effects of an earthquake have the potential to cause as much, if not more damage than the damages caused by the stress imposed on the structure from the movement of the earth. These secondary effects often occur through the result of an earthquake causing a utility line to break or become damaged. For example, damage to an electrical utility service within a structure can cause an electrical fire to occur within the structure that may result in its destruction by fire. Damage to a natural gas line carries with it both a potential to asphyxiate the air breathing inhabitants of the structure, and more likely, to cause explosions and fires that may cause the structure to explode or catch fire and burn to the ground. Further, a break in a water pipe can lead to flooding of the structure, causing significant water damage to the structure, and in certain erosion prone places, cause water induced landslide-type movements to weaken the foundation of any structure unlucky enough to be down stream of a broken pipe.

One difficulty encountered in dealing with earthquakes is that the forces that cause earthquakes are too large to prevent, and the occurrence of an earthquake is almost impossible to predict. For example, if the timing of an earthquake could be predicted, it would be possible for a structure owner, or a utility company to shut off the utility service to any areas close enough to the epicenter of the earthquake most likely to be damaged by the earthquake. Although shutting off the utilities to an area where an earthquake was about to occur would not prevent the primary structural damages caused by the movement of the earth, at least it would help to prevent (or at least reduce the severity of) the secondary damages caused by electrical fires, gas explosions, and water floods induced by breaking utility service lines.

However, since the timing of earthquakes cannot be predicted with anything that even remotely represents certainty, it is almost impossible for a utility company to stop service to an area prior to the occurrence of an earthquake, since the company does not know when the earthquake will occur. Therefore, unless utility service is permanently stopped to an earthquake-prone area, the only practical solution for dealing with the problems caused by utility services after an earthquake, is to shut the services off after the earthquake occurs. However, if it is desirable to be able to shut off the utility service after the occurrence of an earthquake, the first task that must be performed is determining when an earthquake occurs, so that the utilities may be shut off thereafter.

Therefore, it is one object of the present invention to provide a device that is capable of sensing the presence of an earthquake. It is also an object of the present invention to provide a device that, upon sensing the presence of an earthquake, is capable of generating a signal for delivery to a utility service carrier, such as an electrical wire, water pipe or gas pipe, that alerts the utility service that an earthquake is occurring. Additionally, it is an object of the preferred embodiment of the present invention to provide a device that is capable of initiating (and preferably performing) a shut off of the flow of one or more utility services in response to the detection of an emission event, such as a fire, smoke emission or the emission of a hazardous material.

It is a further object of the present invention to provide devices that are capable of receiving the signal that is generated in response to the detection of an earthquake, and then stopping the flow of a utility service in response thereto. Such utility services include the flow of electricity through electrical lines, the flow of gas through a natural gas pipe, the flow of water through a water pipe; and the flow of waste water through a sewage pipe; and the flow of facilities (e.g. factories) that are piped into the facilities for use therein.

Further, it is an object of the present invention to help to reduce the damage caused by an earthquake, by providing a device of the kind described above, that can reduce the secondary damages caused by an earthquake, such as fires and flooding caused by an earthquake's damage to utility flow services, such as electrical lines, natural gas lines and water lines.

### IV SUMMARY OF THE INVENTION

In accordance with the present invention, an earthquake sensor and a control system is provided for sensing the presence of an earthquake event and for shutting off the flow of at least one utility service in response thereto. The earthquake sensor and control system comprises a vibration sensor for sensing vibrations caused by an earthquake. A signal generator is provided for generating a utility flow stop signal in response to an earthquake induced vibration sensed by the vibration sensor. A utility flow control is provided for stopping the flow of the utility service in response to receiving the utility flow stop signal.

The utility service stopped by the utility flow control can be an electrical utility service wherein the utility flow control comprises a circuit breaker. Alternately, the utility service flow stopped by the utility flow control can comprise the delivery of a gaseous or liquid fluid, such as a combustible fluid (e.g. natural gas, heating oil, etc.), or an aqueous fluid (e.g. water line, sewer line). The utility flow control in such cases comprises a valve for shutting off the flow of such a fluid.

Preferably, the device also includes an emission detector for detecting the presence of either one or both of a burning material and a flammable material. A signal generator is provided for generating the utility flow stop signal in response to the detection of at least one of the smoke emitting and flammable materials. The signal so generated is then capable of actuating the utility flow control to stop the flow of the utility service in response to the reception of the utility flow stop signal, generated in response to the detection of the smoke emitting and/or flammable material by the emission detector.

One feature of the present invention is that it is capable of sensing an earthquake. Although emission detectors, such as smoke detectors, exist for detecting the presence of a fire, the Applicant is unaware of any device available currently, for home and commercial use, for detecting the presence of an earthquake. By having this ability to detect an earthquake, an alarm can be sounded to warn occupants within the structure of the existence of the earthquake, along with shutting off a utility service.

It is also a feature of the present invention that a signal generator is provided for generating a signal in response to the sensed earthquake. The signal so generated is capable of actuating a utility flow control device for stopping the flow of a utility service to the place where the earthquake is detected.

As described in more detail above, this feature has the advantage of helping to reduce the likelihood that the secondary earthquake “impacts” will cause additional damage or injury. These secondary impacts often result from breaks or damage caused to utility flow lines, wherein the uninterrupted flow of the utility service into the structure is the agent that causes damage to the structure. For example, damage caused by the primary (shock and earth movement) impacts of an earthquake to an electrical line, can cause an electrical line to cause damage or injuries such as by starting an electrical fire, or electrocuting a living being. Similarly, the uninterrupted flow of a flammable fluid, such as natural gas, LP gas, or heating oil, can help to initiate or accelerate a fire, thus causing fire damage to a structure in addition to the structural damage caused by the earth movement from the earthquake. Further, the uninterrupted flow of water through a damaged fresh water or sewer pipe can cause water and flood damage to a structure.

An additional feature of the present invention is that the device can be designed to permit the user to select the utility flow service(s) that is (are) stopped in the event of an earthquake, or the detection of an emission. For example, the user can program instructions into the system to shut off each of the water flow, gas flow, and electrical flow into a house in the event of an earthquake, but select to only stop the flow of electricity and gas into the structure in the event of a fire. The user might decide to not stop the flow of water into a house in a fire situation, as the water may be helpful and necessary to extinguish the fire.

These and other features and advantages of the present invention will be better understood in connection with the detailed description and drawings set forth below, which represent the best mode of practicing the invention that are perceived presently.

### V. BRIEF DESCRIPTION OF DRAWINGS

FIG. 1 is a schematic representation of the components of the present invention;

FIG. 2 is a front view of a control panel and control device component of the present invention;

FIG. 3 is a schematic representation of the circuitry used in connection with the present invention;

FIG. 4 is a sectional view of the vibration sensor (earthquake detector) of the present invention taken along lines 404 of FIG. 5;

FIG. 5 is a sectional view, taken along lines 5-5 of FIG. 4;

FIG. 6 is an exploded, partly schematic view of circuit breaker of the present invention;

FIG. 7 is a front view of a bimetallic heating element for triggering the cessation of flow of electrical utility service of the present invention;

FIG. 8 is a side view of the heating element of FIG. 7;

FIG. 9 is an alternate embodiment triggering device for triggering the circuit breaker to stop the flow of electricity of the present invention;

FIG. 10 is another alternate embodiment triggering mechanism of the present invention;

FIG. 11 is a side, sectional view of a fluid utility shut off valve of the present invention in its open position;

FIG. 12 is a side, sectional view of a valve of FIG. 11 in its closed position, wherein the flow of a utility service is stopped;

FIG. 13 is a schematic view illustrating the various components of the present invention installed in a single unit, multi-room structure, such as a residence; and

FIG. 14 is a schematic view illustrating the present invention installed in a multi-unit, or large structure, such as an apartment building, large industrial facility, shopping center, etc.

### VI. DETAILED DESCRIPTION

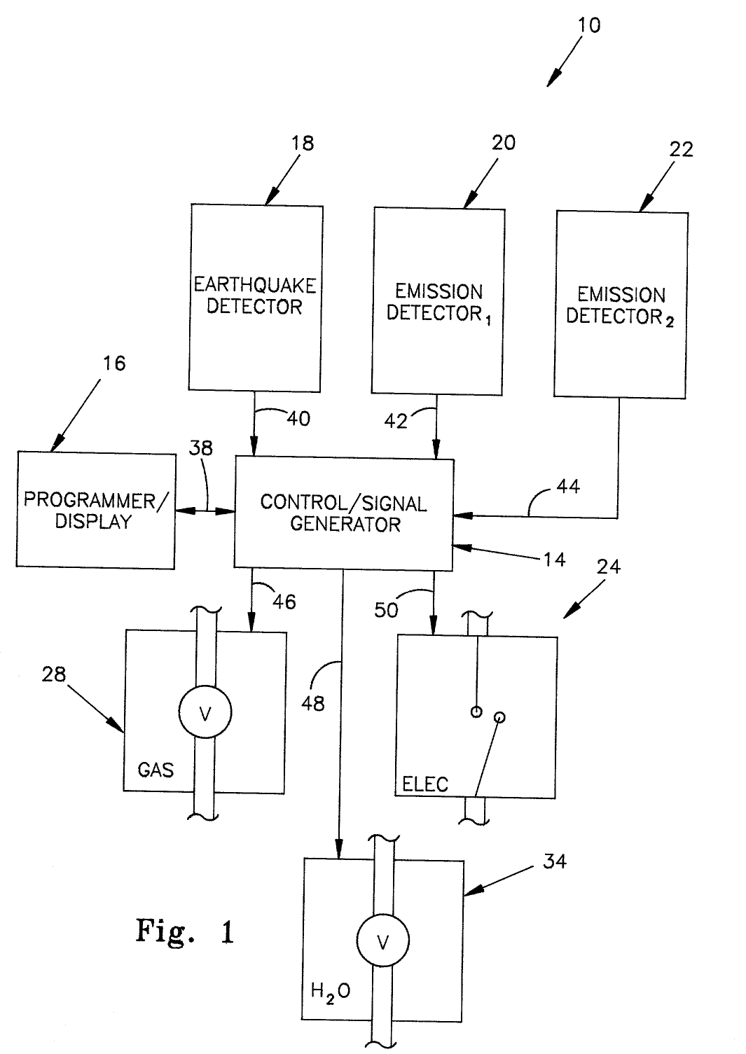

An earthquake sensor control system 10 for detecting the presence of an earthquake event and for shutting off the flow of at least one utility service in response thereto is shown in the drawings. Turning first to FIG. 1, the earthquake sensor control system includes several components, some of which may be housed in a single housing, such as a single housing that contains all of the control/signal generator 14, the programmer/display 16, the earthquake detector 18 and one or both of the emission detectors 20, 22. Other components may be housed in separate casings located remotely from the control/signal generator 14. Although the earthquake detector 18 is preferably located in the control/signal generator 14 housing, it can be located remotely thereto. By comparison, although the various utility flow service valves (e.g. electric circuit breaker 24, gas shut off valve 28, and water shut off valve 34) can be positioned within the control/signal generator 14 housing, they are preferably positioned somewhere remote from the remainder of the components.

The earthquake sensor and control system 10 of the present invention includes three primary component groups.

The first component group consists of the sensors whose purpose is to sense the presence of an earthquake, or other event for which detection is desired. These sensors include an earthquake detector 18, a first emission detector 20, and a second emission detector 22. The earthquake detector 18 comprises a vibration sensor capable of sensing vibrations caused by an earthquake. As will be discussed in more detail below, the earthquake detector includes a signal generator for generating a utility flow stop signal in response to the earthquake induced vibration sensed by the vibration sensor.

The first emission detector 20 is designed to sense the presence of an undesirable emission. One such type of emission detector is a smoke detector. Another kind of emission detector is a “sniffer” type detector that detects the presence of a hazardous or flammable material, such as natural gas, heating oil or other flammable hazardous material, even though the particular hazardous or flammable material has not yet erupted into a fire.

As shown in FIG. 1, the device 10 includes two emission detectors, a first emission detector 20, and a second emission detector 22. The type of emissions detector that are chosen for first emission detector 20 and second emission detector 22 can be varied, depending upon the desires of the user. For example, the first emission detector 20 and second emission detector 22 may be detectors that are physically located close to, or at the site of the control/signal generator 14, and that are each designed to detect different types of emissions. As such, the first emission detector 20 can be a smoke detector, and the second emission detector 22 can be a flammable/hazardous material sniffer.

Alternately, the emission detectors 20, 22 can each be the same type of detectors (e.g. both smoke detectors) that are placed in different locations within a structure. For example, first emission detector 20 can be a smoke detector that is placed in the kitchen of a residence, whereas the second emission detector 22 can comprise a smoke detector that is placed in the bedroom of the residence. Although two emission detectors 20, 22 are shown in the drawings, it should be understood that a plurality of emission detectors in excess of two could be employed. For example, the owner of a 14-room house might choose to place both a smoke detector and a hazardous material/flammable material sniffer-type detector in each of her 14 rooms, thus resulting in 28 emission detectors being coupled to the control/signal generator 14.

One general requirement of the emission detectors is that they be coupled, such as by hard lines 42, 44, or wireless connections to the control/signal generator 14, so that the signal generated by each of the emission detectors 20, 22 in response to a detected emission can be transmitted to the control/signal generator 14. Preferably, two-way communication is preferred, so that the control/signal generator 14 can transmit signals that it generates to each of the emission detectors 20, 22, and also enable signals from each of the first 20 and second emission detectors 22 to be transferred between each other.

For example, as many smoke detector-type emission detectors contain an audible alarm device, it may be desirable for one emission detector (e.g. 20) to set off the audible alarm in the other emission detector (e.g. 20) if a fire erupts in the room in which the one emission detector is placed. Therefore, if a fire erupted at night in the kitchen of a dwelling, the first emission detector 20, located in the kitchen, could generate a signal, that would be forwarded to the control/signal generator 14. Upon receipt of the signal by the control/signal generator 14, the signal would then be transferred to the second emission detector 22 located in the bedroom. When receiving this signal, the audible alarm of the second emission detector 22 in the bedroom would begin sounding, thus alerting the occupants of the bedroom of the fire. Because of the proximity of the audible alarm to the place where the occupants are sleeping, the bedroom occupants would be more likely to be awakened.

Similarly, the earthquake detector 18 is either hard-wired, such as by wire 40, or wirelessly connected to be in communication with the control/signal generator 14, for transmitting a signal generated in response to a sensed, earthquake related vibration to the control/signal generator 14.

The control/signal generator 14 comprises the “central brains” of the system, and is provided both for enabling the user to control the operation of the earthquake detection and the detection and control system 10, and to also generate appropriate signals, where necessary, in response to detected earthquakes and emissions, and to transmit those generated signals, to the electric utility service flow control device 40, via hard-wire connection 50; to the water utility service flow control device 34 via hard-wire connection 48; and also to gas flow control device 28, through hard wire connection 46. As stated above, connections 46, 48 and 50 can be substituted with wireless links.

The choice of whether to employ hard wire links or wireless links is determined largely by factors such as reliability, installation ease and cost. Applicant believes that a hard wire connection would be less expensive and more reliable than a wireless connection, although it likely would be more difficult and expensive to install, especially when installed in existing structures.

A programmer/display 16 is communicatively coupled, preferably by hard wiring 38, to the control/signal generator 14. Depending upon the desires of the user, the programmer/display 16 can include a variety of features, that enable the user to vary the operation of the earthquake sensor and control system 10. Additionally, the display portion of the programmer/display 16 can be designed to be small, inexpensive, and provide only limited information. Alternately, it can be larger, more expensive and provide significant information to the user, depending upon the desires of the user.

Turning now to the three flow controls, the electric flow control 24 preferably comprises a circuit breaker 24, having a switch mechanism that is triggered, in the event of a detection event, such as the detection of an earthquake, a fire, or the presence of a hazardous/flammable emissions or materials, to stop the flow of electricity utility service sent to the structure. Preferably, the electricity controlling circuit breaker 24 is positioned near the electrical junction box of the structure, as that is the area of the structure in which the outside electrical lines deliver the electricity to the structure. The electricity flow control device 24 should also be disposed “upstream” in the flow of electricity from the structure's “circuit breaker junction box”, in generally the same position as the electrical master breaker, so that a single circuit breaker switch can immediately stop the flow of all electricity into all circuits of the structure. Of course, in structures having multiple junction boxes wherein multiple electrical lines deliver electricity to the structure at different places, it is likely that multiple electric flow control circuit breakers, such as breaker 24, would be required, with one being used for each of the electrical lines and/or junction boxes.

A water flow control valve 34 should preferably be disposed adjacent to the main water inlet pipe that delivers water into the structure. As with the circuit breaker 24, the water flow control valve should be placed at the main water entrance pipe, so that a single valve 34 will be able to stop the flow of all water into the structure. Although not shown, a water flow control valve can be disposed within the main sewer outflow pipe, to stop the flow of sewage out of the house or the inflow of sewage into the house in an earthquake event.

Similarly, gas flow control valve 28 should be positioned adjacent to the main gas intake pipe (not shown) of the house, which is usually located adjacent to the gas meter of the structure.

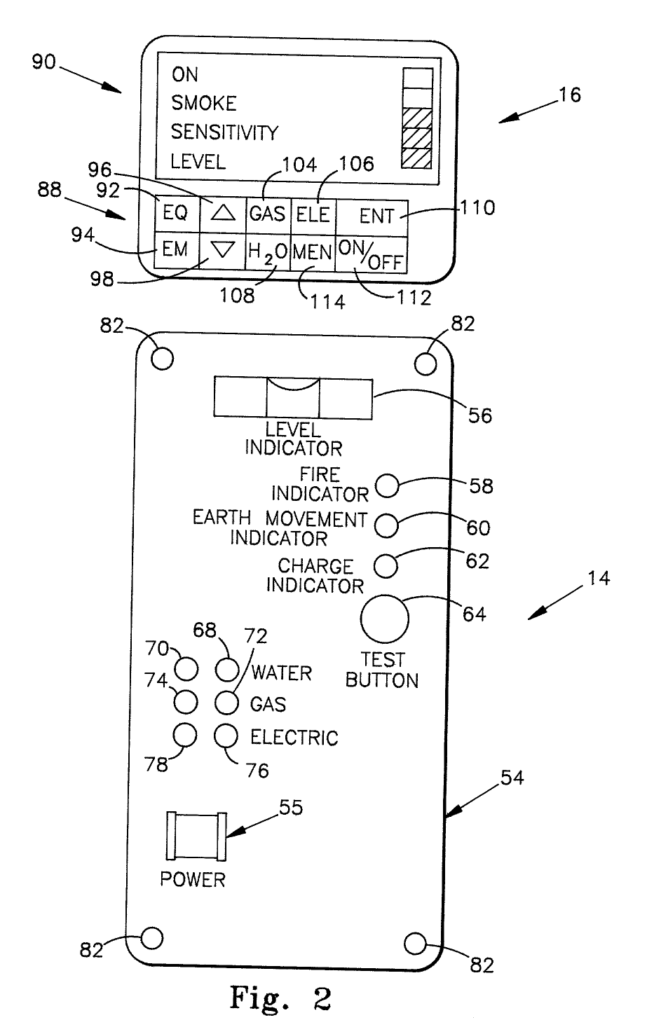

As is true with the electric service flow control interrupter 24, multiple gas and/or water flow control interrupters 28, 34 respectfully, may be required in structures wherein the gas and water are delivered to the structure through multiple inflow lines. The outer casings of the control/signal generator 14 and programmer display 16 are shown in FIGS. 2. The control/signal generator 14 includes a case 54 that is preferably made from an injection molded plastic, and a power switch 55 that is provided for actuating the unit. A level indicator 56 is provided for ensuring that the control/signal generator 14 is installed level to the earth. The level installation of the control/signal generator 14 is highly desirable, due to the fact that the control/signal generator 14 case 54 also preferably contains the earthquake detector 18, whose operation depends upon the detector 18 being set up level to the ground.

Control/signal generator 14 includes a plurality of indicator lights, including a fire indicator 58, and an earth movement indicator 60, 62. Preferably, each of the indicators 58, 60 comprise LEDs, that are normally in their “off” position, but which light up in the event of a fire (the fire indicator 58), or an indication of detected earth movement (earth movement indicator 60).

Unlike the fire indicator 58 and the earth movement indicator 60, the charge indicator LED 62 is normally in an “on” or lighted configuration, and either turns to an “off” mode, or alternately, may be designed to flash on and off if fire has interrupted the flow of “outside” AC type electrical current thereto, thereby forcing the charge indicator 62 and earthquake detection system 10 to be operating on back up battery power, or to go completely off in the event that the device is inoperable due to the back up battery being dead.

A series of status lights are also provided to give the user an indication of the status of the various utility flow services that are affected by, and under the control of the earthquake detection and control system 10. These LED type displays include a “water-on” indicator 68, that is preferably green in color (indicating the water flow as normal). A water interrupt indicator 70 (preferably a red LED) is provided to indicate that water flow is interrupted, due to the shut off valve (that is a part of the system) being tripped to close.

Similarly, a green “gas-on” indicator 72 is provided for indicating the gas flow is normal, and a red LED gas interrupter LED indicator 74 is provided to indicate that the flow of gas has been interrupted due to the gas shut off valve being triggered to close. Finally, an “electric-on” indicator light 76 is provided to indicate that electric flow is normal, along with a red LED type light electric interrupter indicator 78 that is provided for indicating that electric service has been interrupted, due to the earthquake detection control system 10, control/signal generator 14 sending a signal to the circuit breaker 24 to stop the flow of electricity into the circuit.

The existence of an electrical interruption light 78 begs the question of how the LED indicator 78 can be lit when the AC electrical current to the structure (in which the control/signal generator 14 resides) has been turned off. To cover this eventuality, the control/signal generator 14 includes a battery back up power source, so that the control/signal generator 14 can continue to operate in the event that the electricity to the control/signal generator 14 is shut off. This battery back up power provides enough power to generate the signals necessary to actuate the gas flow controller 28, water controller 34 and electric controller 24 in the event that electricity has been cut off to the structure. As will be appreciated, this feature is especially useful to enable the system 10 to stop the flow of utility service to a structure in the event that electricity is cut off to the control/signal generator 14 before the control/signal generator 14 senses the presence of the earthquake event, such as might occur if an outside line break occurs before the earthquake is detected at the structure.

Four mounting screws 82 are provided for mounting the case 54 either to a back plate frame that carries the components of the control/signal generator 14, or alternately directly to the wall. In this regard, the case 54 can be designed to have a plastic dish-shaped top that forms the cover, and a back plate designed to serve as a frame on which the components are mounted. In such cases, the purpose of the mounting screws 82 could be merely to attach the case cover 54 to the frame (not shown), wherein the removal of the case 54 would leave the frame mounted onto the wall. In this type of construction, the wall-mounted frame would also include one or more mounting devices, such as screws, double-stick tape, or the like for fixedly attaching the frame (not shown) to a wall (not shown). As an alternative, the programmable control/signal generator 14 could be designed so that the removal of the mounting screws 82 removes the case 54 and back frame from the wall (not shown).

The programmer/display 16 is shown in FIG. 2 as being contained within a separate case that is attached adjacent to the control/signal generator 14. Alternately, the programmer/display 16 and the control/signal generator 14 can be made into a single, unitary unit, sharing the same case 54. In any event, the circuitry of the programmer 16 is in communication with the control/signal generator 14 to permit electrical communication signals to pass therebetween.

The programmer/display 16 includes a series of actuation buttons 88 that permit the user to program the desired functions into the programmer/display 16, and hence the control/signal generator 14. The programmer/display 16 also includes a display panel 90 for displaying information about the operation status of the control/signal generator 14, and for providing a guide to help the user program the operation of control/signal generator 14 through the use of the actuatable buttons 88.

A plurality of exemplary actuable button controls are shown in FIG. 2. However, it will be appreciated that the actuatable buttons 88 could have a very different configuration from that shown, depending upon the desires of the user and manufacturer. Importantly, the various actuatable buttons 88 should be designed to facilitate easy programming of the control/signal generator 14, while still maintaining cost and space efficiencies achieved by use of a fewer number of buttons (rather than a larger number). In this regard, the primary importance of the discussion below is to help illustrate some of the various functions that are likely to be desirable to incorporate into the programmer/display 16, to better enable the user to achieve the desired results in his/her programming of the device 10.

As shown in FIG. 2, the illustrative actuable buttons 88 for the programmer/display 16 include an earthquake button 92, that the user would push when wishing to program information into the control/signal generator 14 that relates to the detection of earthquakes. Similarly, an emissions button 94 exists that the user would employ when she desired to program information into the control/signal generator 14 relating to the emissions detected. Up and down buttons 96, 98 are provided both to permit the user to adjust various quantity levels associated with the programming of information into the device 10, along with enabling the user to navigate around the display 90. A gas control button 104 is actuated when the user wishes to control the operation of the gas flow control valve 28. Similarly, a water flow button 108 and an electric flow button 106 are pushed by the user when he wishes to program information into the device relating to the control of the water shut off valve 34 and the electric circuit breaker 24. An enter button 110 is provided to enable the user to cause program information to be entered into the programmer's 16 memory, and an on-off button 112 is provided to enable the user to turn the display on and off. A menu button 114 is provided to enable the user to select among the various menus provided on the display 90.

The display 90, displays several different types of information. For example, the information shown on the display 90 in the drawing suggests that the device is turned on and actuated. Additionally, the display shows a “smoke sensitivity level”, that is a menu requested item that permits the user to know that the information he is programming into the device relates to the smoke sensitivity level. Finally, a bar graph is provided to give the user a semi-quantitative display of the value being programmed into the device 16.

The material displayed on the display 90 helps to illustrate one of the features of the present invention, as the display illustrates that the user can program into the device the threshold sensitivity at which the device will respond to a smoke-type emission, by shutting off the flow of utility services. For a variety of reasons, the user may wish to adjust the sensitivity, depending upon the area in which the emission detector is being employed. For example, the user may wish to decrease the sensitivity level of the device for an emission detector, such as a smoke detector, that is placed in a kitchen of a structure where smoke is likely to be generated from normal kitchen-type activities, such as the frying of bacon, to ensure that the device does not create an audible alarm, or shut off the flow of electricity due to the emission of an amount of smoke typically incident to the cooking of food on a stove. On the other hand, the user might select to increase the sensitivity level of an emission detector placed in a bedroom, as a bedroom normally does not encounter much smoke. As such, the presence of smoke in a bedroom (as opposed to a kitchen) will likely suggest the presence of a hazardous condition, such as a fire. Therefore, the user would desire that the smoke detector would generate a signal to the control/signal generator 14 to sound an audible alarm, and/or shut off the utility service in the event of a lower level of smoke being sensed by an emission detector in a bedroom, than in a kitchen.

Additionally, the device 10 can have the capability of varying the sensitivity level of the emission and earthquake detectors, separately from the sensitivity level at which the control/signal generator 14 generates the signal to set off an audible alarm, which itself can be separate from the sensitivity level at which the control/signal generator 14 shuts off a utility service. For example, the user might program the device so that at a first, relatively lower smoke level, an emission detector placed in the kitchen of the structure generates a signal to cause the control/signal generator 14 to generate a signal to set off an audible alarm, but not cut off the flow of electricity, water, gas or other utility services. As such, a level of smoke great enough to set off the alarm, such that might occur from the frying of bacon, would set off an audible alarm that would warn the occupant of the high level of smoke, without shutting off the water to the shower, or the electricity to the stove.

Similarly, the user may cause the earthquake detector to set off an audible alarm at a relatively lower level, such as one that might be caused by excessive rumblings within a house, or the passage of a very large truck at a very high speed in close proximity to the structure, but would not shut off the electricity, water and gas as a result thereof. Conversely, the user could set a high sensitivity level for both the emission detector, and the earthquake detector, so that an abnormally high level of smoke (such as would be caused by an uncontrolled fire), or an excessively high amount of vibrations (such as would be caused by an earthquake), would cause the control/signal generator 14 to generate a signal that would be forwarded to the respective electric circuit breaker, gas shut off valve, and water shut off valve to cease the flow of electricity to one or some combination of such valves in response to the sensed, abnormally high level of emissions or vibrations.

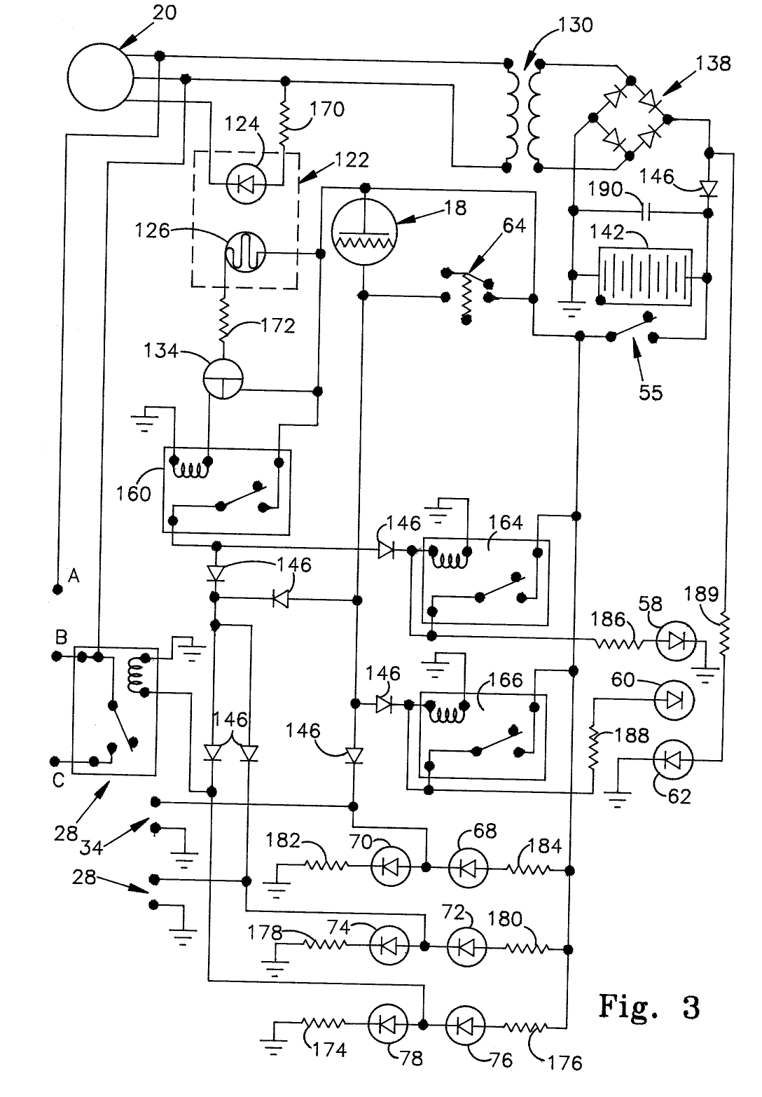

Turning now to FIG. 3 a schematic representation is shown of the various components and circuitry that connects the components. As will be noted, many of the components discussed earlier in connection with FIGS. 1 and 2 are represented by the same numbers in the schematic, as they are in the drawing of the control panel (FIG. 2), and the schematic drawing of the various components (FIG. 1).

The circuitry includes an optoisolator 122 that is provided that includes a first light emitter 124, and a light receptor 126. The purpose of the optoisolator is to detect a signal from the emission detector 20 during the occurrence of an emission event. An optilisolator 122 is used because it is useful to keep the electrical circuitry of the earthquake detector 18 separated from the electrical circuitry that drives the emission detector 20, to ensure that the device 10 operates properly. A transformer 130 is used to reduce the alternating currents that provides the main source of power for the device 10, from a high potential to a lower potential. A rectifier bridge 138 is used to convert the alternating currents provided by the AC power source to a direct current. The transistor 134 is employed to turn on the relay 160 when the optoisolator detects the signal from the smoke detector 20, to cause the device to generate a signal to the various water shut off valves 34, gas shut off valve 28, and electrical circuit breaker utility service cut off 24.

A re-chargeable battery 142 is provided for back up power for the device 10. As discussed above, a battery back up source is very useful to incorporate into the device, in cases where electrical power to a structure is cut off at a time before an emission or earthquake event is detected by the appropriate detector. In such situation, even though the device 10 would not necessarily need to send a signal to the circuit breaker 24 (as the electricity is already cut off), a signal must still be sent to the gas shut off valve 28 and the water shut off valve 34. Additionally, even if power has been discontinued to a structure, it is valuable to ensure that the electrical service is shut off to circuit breaker 24 in the event of a sensed earthquake, to ensure that the restoration of electrical service to the structure will not cause electrical utility service to be restored to the structure, even though electrical lines of any circuit that are within the structure could have been damaged or broken.

A plurality of diodes 146 are provided for limiting current flow through the circuit, to flow in a single, desired direction.

A plurality of lighting emitting diodes 68, 70, 72, 74, 76, 78, are provided that indicate that either a utility service is normal, or is interrupted, and which are contained on the front of the control panel, along with the fire indicator light diode 68, the earth movement indicator LED 60, and charge indicator LED 62. All three are provided to perform the functions discussed above in connection with FIG. 2. On-off switch 55 is provided as the main on off switch for the device 10.

A first relay 160 is provided to handle the load of all the utility interrupting components, including the electric utility service circuit breaker 24, the water shut off valve 34 and a gas shut off valve 28. Second relay 164 is used to turn on, and maintain the power to the fire indicator 186. Third relay 166 is used to turn on, and maintain the power to the earth movement indicator LED 188.

A series of the resistors are also important employed in the circuitry. A first resistor 170 is provided for limiting the current from smoke detector (and emission detector 20) to the optoisolator 122. A second resistor 172 is provided for limiting the current to the optoisolator 124. A third resistor 174 is provided for limiting the current to the interrupter LED light 78 that indicates that the flow of electricity has been interrupted. A fourth resistor 176 is provided for limiting the current to the circuit continuity LED 76 for the electricity. The fifth resistor 178 limits the current to the interrupter LED 74 that indicates that the gas flow has been interrupted; and a sixth resistor 180 limits the current to the circuit continuity indicator LED 72 for the gas flow.

A seventh resistor 182 limits the current to the interrupter LED 70 that indicates that water flow has been interrupted, and the eighth resistor 184 limits the current to the circuit continuity indicator LED 68. A ninth resistor 186 is provided for limiting the current to the fire indicator 58; a tenth resistor 188 is provided for limiting the current to the earth movement indicator LED 60; and an eleventh resistor 189 is used to limit current to the change indicator 62.

As described above, the test button 64 is used to test all of the interrupters on the various circuits within the device 10.

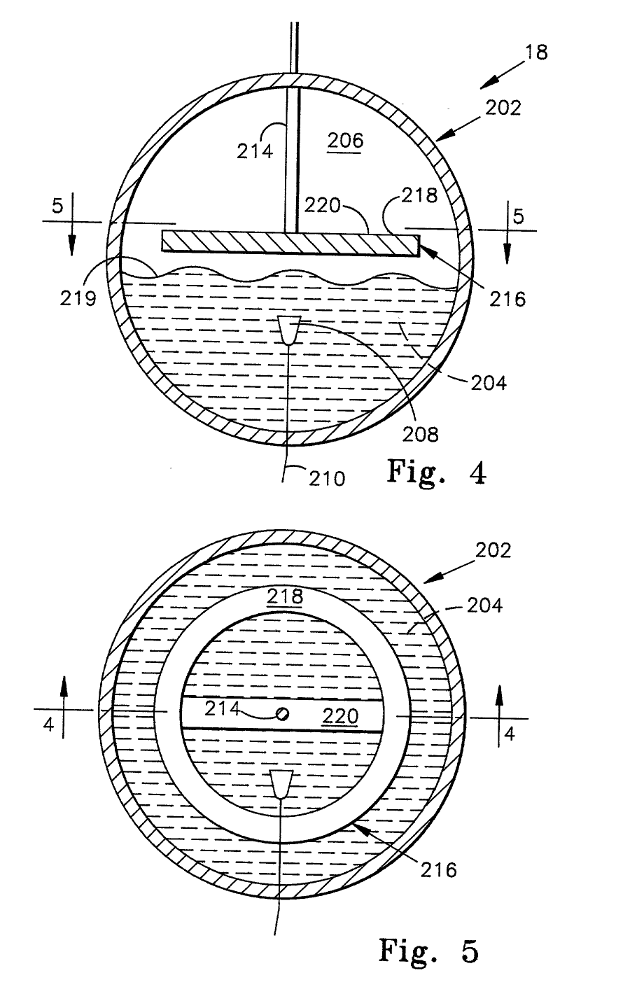

Turning now to FIGS. 4 and 5, the earth movement sensor 18 will be described. The earth movement sensor 18 is designed to detect an earth movement, and more particularly the vibrations incident to an earth movement. Once detected, the earth movement sensor 18 converts the sensed movement of the earth into an electrical or mechanical signal. In the earth movement sensor 18 of the present invention, the detected movement of the earth results in the generation of an electrical signal.

In many large geological movement detection facilities, the movement of the earth is detected by a pendulum, to which sensors are applied to detect movement of the pendulum. For example, in the Indiana University Geology building, an elevator shaft is used to house the pendulum comprising a very large weighted bottom that is suspended by a very long cable. Movement of the earth (even at great distances from Bloomington, Indiana) results in movement of the pendulum. Sensors coupled to the pendulum detect movements of the pendulum, which movements are indicative of geological movements, such as earthquakes.

One difficulty with the pendulum-type sensor is that it is too costly and large to be suitable for use in most structures, such as houses. The earth movement sensor 18 of the present invention is designed to be small, accurate and reliable. Importantly, it is designed to be small enough and inexpensive enough to fit within a small package, such as the control/signal generator 14, and be inexpensive enough for wide-spread use in commercial and residential structures.

The earth movement sensor 18 comprises a generally spherical vessel, that is preferably made from a durable, yet non-conductive material such as glass. The spherical shape for the vessel was chosen both because of its ability to contain the mercury, and because of the advantages obtained by its shape. Being spherical in shape, the vessel promotes the free movement of a conductive fluid 204, that preferably comprises mercury, to move freely from side to side within the spherical vessel 202, thereby allowing optimum operation of the sensor 18. As will be appreciated, a vessel that is shaped in a manner that restricts the movement of the conductive fluid 204, might be unable to detect small earth movements.

The sensor includes a pre-determined amount of mercury 204 contained within the interior of the vessel. The amount of mercury 204 chosen for inclusion into the vessel 202 is large enough to provide a workable quantity of mercury, while still permitting an air space 206 to be formed above the upper surface of the mercury 204.

A first contact 208 is submerged within the mercury 204. A lead line 210 connects the contact 208 to the circuitry (FIG. 3) of the control/signal generator 24. A second contact 216 is suspended above the upper surface 209 of the mercury 204, so that the second contact 216 is normally disposed within the air space 206 above the mercury 204. A second lead wire 214 couples the second contact 216 to the circuitry (FIG. 3) of the control/signal generator 24.

The second contact 216 is designed to preferably have a large amount of surface area, to facilitate the physical contact between the mercury 204 and the contact 216 in the event of an earthquake event. To accomplish this end, the illustrative contact 216 shown in FIG. 4, has a disk-washer shape, including a disk-shaped ring portion 218, and a diametral cross member 220, to which the second lead line 214 is coupled. Although other configurations and shapes could be employed that achieve the desired large surface area, while providing a convenient contact point for the second lead line 214, the Applicant has found that the disk-shaped washer serves its purpose well, in a spherical container. The second lead line 214 not only provides an electrical contact between the second contact 216 in the circuitry of the control/signal generator 24, but also suspends the contact 216 in its appropriate place within the spherical vessel 202.

The operation of the sensor 202 will be affected by the size and shape of the contact 216; and also the distance of the contact from the upper surface 219 of the pool of mercury 204. In regard to distance, the closer the placement of the contact 216 to the upper surface 219 of the mercury 204, the smaller the vibration that is required to place the electrically conductive mercury 204 in contact with the second contact 216, to thereby indicate to the device 10 that an earthquake event has occurred through the generation of a signal. Conversely, increasing the gap size between the contact 216 and the upper surface 219 of the mercury 204 will generally require a greater amount of vibration to occur before an earth movement signal is generated at a sensor 202.

The gap between the contact 216 and the upper surface 219 of the mercury 204 should be adjusted so that the gap is sufficiently great so that small vibrations (such as children running close by) will not cause contact between the mercury 204 and the contact 216. On the other hand, the gap should be close enough so that a true, but small earth movement will create enough vibration to cause contact between the mercury 204 and the second contact 216, thereby generating a signal that indicates movement of the earth, so that operation of the device 10 is triggered.

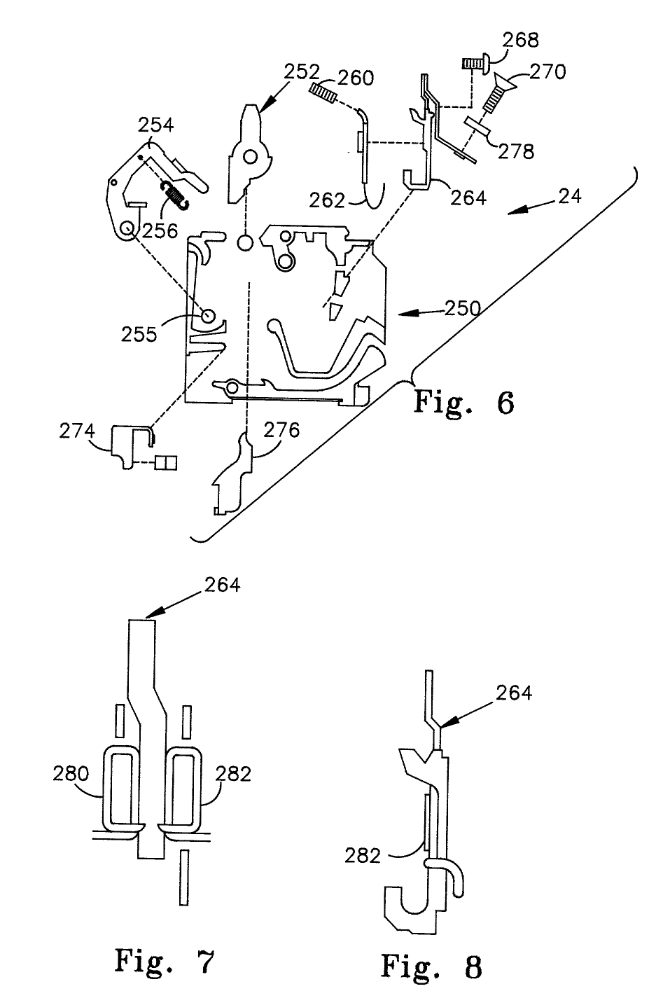

Your attention is now directed to FIG. 6, that shows an exploded view of the inventive circuit breaker of the present invention. As discussed above, the circuit breaker 24 of the present invention is designed to receive a signal generated by the control/signal generator 24 that either an earth movement event or an emission event has occurred, and as a result of this received signal, stop the electric service to the structure served by the circuit breaker 24.

The circuit breaker 24 includes a toggle 252 that is used to re-set the circuit breaker 24 when it is tripped to cause the flow of electricity to cease. The toggle 252 is also used to turn the circuit breaker 24 (and hence the electricity flow) on and off. Toggle 252 is used both when the circuit breaker 24 is turned off as a result of an electrical disturbance, such as too much amperage being drawn through the circuit, and also when the circuit breaker 24 is tripped as a result of an emission event or an earthquake event. Additionally, toggle 252 is used to turn the circuit breaker 24 on and off when the home owner or maintenance person so desires to stop or start the electricity flow within the structure.

A lever 254, is pivotably moveable about a pivot point 255. The movement of the lever 254 about pivot point 255 controls whether the circuit is on, or is tripped to close. A first spring 256 maintains the tension on second contact 276, when the lever 254 is in the “on” position. When the lever is in its “off” or tripped position, the first spring 256 relaxes, thereby allowing the first contact 274 to move away from the second contact 276 which stops the flow of electricity to the circuit breaker 24. A bi-metal strip 262 bends in response to the heat applied to it by a heating element that is formed as a part of the heating element housing 264.

Under normal circumstances, the flow of too much amperage through the circuit breaker 24, causes the heating element to heat up, thereby bending the bi-metal strip 262. The bending of the bi-metal strip 262 thereby causes the lever to trip, to place the first contact 274 out of contact with the second contact 276.

Turning now to FIGS. 7 and 8, the heating element housing 264 contains a first heating element 280 and a second heating element 282. A pair of heating elements 280, 282 are utilized in the heating element housing so that the circuit breaker 24 can operate according to the present invention.

The first heating element 280 is heated in response to an over-amperage condition. The second heating element 282 is heated in response to a signal generated by the control/signal generator 24, in response to the detection of an earthquake event or emission event. Through the heating of the second heating element 282 in response to this generated signal, the heating element will cause the lever 254 to trip, which, as described above, results in the first contact 274 becoming spatially separated from the second contact 276. As also described above, the spatial separation of the first and second contacts 274, 276 results in the cessation of the flow of electricity through the circuit breaker 24, thereby effectively “cutting off” the flow of an electrical utility service to the structure served by the circuit breaker 24. A first screw 268 is provided for retaining the heating element housing 264 onto the main body 250 of the circuit breaker 24. A second screw 270 holds the wire retainer 278 in place on the heater element 264.

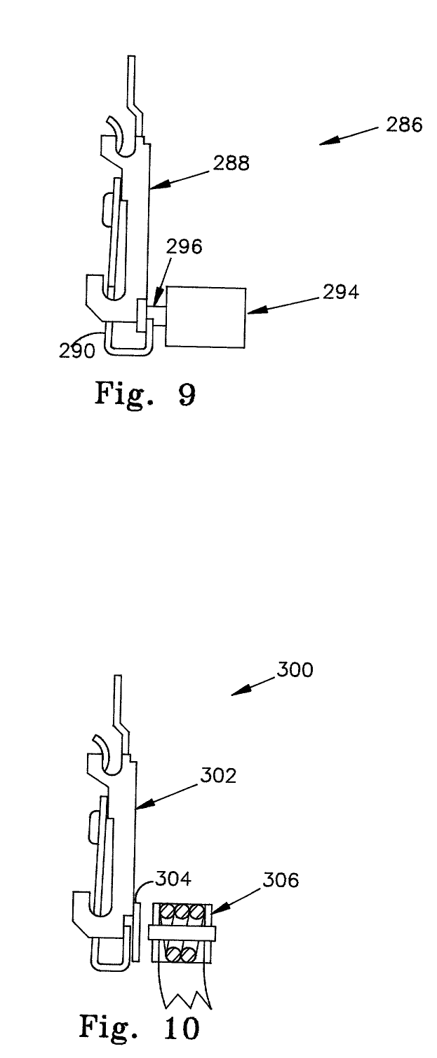

Alternate embodiment heater elements are shown in FIGS. 9 and 10 that include a solenoid actuated heater element housing 286 (FIG. 9) and a magnetically actuated heater element housing 300 (FIG. 10). As best shown in FIG. 9, a heater element 288 includes a bimetallic strip 290. The bimetallic strip 290 is coupled to the actuating arm 296 of a solenoid 294. Upon receiving a signal generated by the control/signal generator 14, that either an earthquake event or an emission event has occurred, the solenoid 294 causes the actuated arm 294 to be actuated, such as by moving inwardly or outwardly. This movement of the actuated arm 296 causes the bimetallic strip to bend, thereby causing the lever 254 to move the first contact and second contact 274, 276 away from each other to thereby stop the flow of electricity through the circuit breaker.

A magnetically actuated heater element housing 300 is shown in FIG. 10 as including a heater element 302, having a metal plate 304 on its rearward surface. An arm containing electro magnet 306 is positioned adjacent to the plate. When the signal generated by the control/signal generator 14 is forwarded to the arm and magnet 306, the magnet 306 and metal plate 304 will either attract or repel (depending upon the design), to thereby causing the bi-metal strip to bend, to thereby trip the lever 254, resulting in the movement of the first and second contact 274, 276 out of engagement, to stop the flow of electricity to the circuit breaker 24.

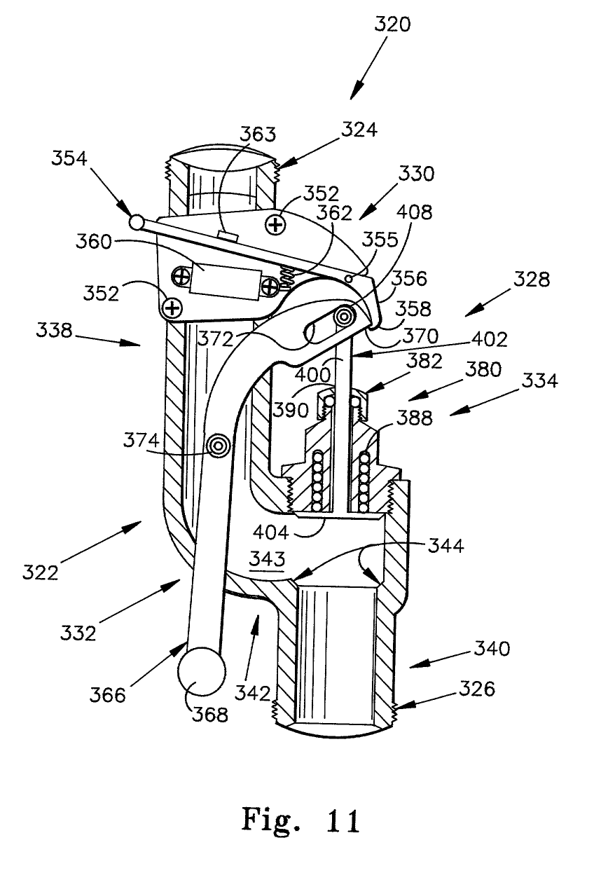

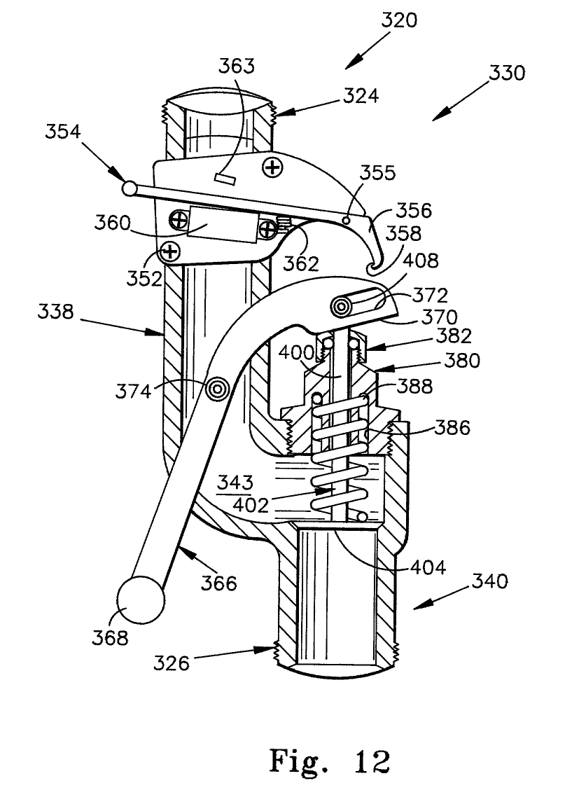

A fluid shut off valve 320 for use in connection with the present invention is shown in FIGS. 11 and 12. The fluid shut off valve 320 shown in FIGS. 11 and 12 can be used either as a water shut off valve, or as a gas flow shut off valve. FIG. 11 illustrates the fluid shut off valve 320 in its open position wherein fluid (either gaseous or liquid) can flow therethrough. FIG. 12 illustrates the shut off valve 320 in its closed position, such as would occur after an emission event or earth movement event that cause a signal to be generated and transmitted to the flow shut off valve 320 to close (FIG. 12).

The gas/fluid shut off valve 320 comprises a pipe section, having an upper connector fitting 324 at one end, and a lower connector fitting 326 at the other end. It will be appreciated that the terms “upper” and “lower” are used for purposes of reference for the valve 320 as it is depicted in the drawings. However, the fluid shut off valve 320 will operate in any orientation (such as upside down to that shown in FIGS. 11 and 12), and as such, the terms “upper” and “lower” should not be read to be limiting.

The upper and lower connector fittings 324, 326 are provided to permit the gas/fluid shut off valve 320 to be installed in a fluid pipe system (not shown). Although the connector fitting 324, 326 are shown as having male-threaded surfaces, it will be appreciated that any other suitable coupling arrangement (e.g. female fittings, welded joint, etc.) that is capable of securely containing the fluids at the joints could be substituted for the male threaded fittings shown in the drawings.

The gas/fluid shut off valve 320 also includes a trigger valve assembly that is selectively engageable with the latch mechanism, wherein the trigger valve assembly can be held in its “open” position to allow fluid to flow through the gas/fluid shut off valve; or triggered to move to a closed position (FIG. 12) wherein the flow of fluid is not permitted through the gas/fluid shut off valve 320. A re-set mechanism 332 is provided for permitting the user to re-set a “closed” gas/fluid shut off valve (FIG. 12) to its opened position (FIG. 11). A valve mechanism 334 is provided for engaging a valve seat 344, to thereby provide a blockage site within the interior 343 of the gas/fluid shut off valve 320, to prevent the flow of fluids through the gas/fluid shut off valve 320, when the valve mechanism is closed.

The pipe section 322 includes an upper portion 338 that is disposed adjacent to the upper connector fitting 324, a lower portion 340 that is disposed adjacent to the lower connector fitting 326, and a middle portion. The middle portion includes an elbow-shaped bend 342, that terminates at a valve seat 344. Valve seat 344 is designed to matingly, and sealingly engage with a head 404 of a shut off valve 402.

The fluid flow shut off valve 320 includes a main plate 348 that is coupled to the upper pipe section by a “C”—shaped mating bracket (not shown). A pair of mounting screws 352 are provided for coupling the plate 348, (to the “C”—shaped mounting bracket, that surrounds the upper pipe portion 348. A pivotable lever release member 354 is pivotably coupled at pivot member 355 to the plate 348. The lever release member 354 includes a forwardly mounted jaw 356 that terminates in an engaging lip 358. An actuating member such as solenoid 360 (or electro magnet, not shown) is provided for moving the lever release 354 between its re-set lever arm 366 engaging position (FIG. 11) and its release position (FIG. 12). A spring 362 extends between solenoid 360 and the lever arm release 354 and acts to pull the lever release 354 downwardly toward it, when the lever release 354 is in its disengaged position. A stop member 363 is provided for limiting the amount of pivotal movement of the lever release 354 in a counter-clockwise direction.

The release mechanism includes a re-set lever arm 366 having a user engageable release handle 368 disposed at one end, and a jaw engaging tooth portion 370 disposed at the other end. The tooth portion 370 is sized and configured to engage the engaging lip 358 of the pivotable lever release 354. Re-set lever arm 366 also includes a flat-sided ovaliod slot 372 that is sized and configured for receiving a bearing 408 that it disposed at the upper end of the valve stem 402. A pivot pin 374 pivotably couples the re-set arm 366 to the valve mechanism 320.

The valve assembly includes a valve guide 380 that includes male threads at its lower end, for threadedly engaging a corresponding set of female threads formed in the pipe 338. An end cap and seal 382 are threadedly engaged to the upper end of the valve guide 380. The valve guide 380 also includes a cylindrical, blind bore-type spring retaining slot 386 in which a spring 388 resides. As will be discussed in more detail below, when the valve 320 is in its open position, as shown in FIG. 11, the spring 388 is compressed, and under pressure. When the valve moves into its open position, as shown in FIG. 12, the spring 388 expands to urge the valve 404 into engagement with the valve seat 344.

The valve assembly also includes a shut off valve member 402 having a valve stem 400. A disk-shaped valve head 404 having beveled edges for engaging valve seat 334 is disposed at one end of the valve stem 400. A bearing member 408 is disposed at the upper end of the valve stem 400, and is sized and configured for engaging the flat side ovaloid slot 372 of the re-set lever arm 356.

Turning now to FIGS. 11 and 12, the operation of the valve 320 will be explained.

Normally, the valve 320 is in its open position as shown in FIG. 11. When in this position, the user-engageable handle 368 of the lever arm 366 is moved to its fully counterclockwise position. As the spring 362 is biased to pull the pivotable lever release 354 in a generally counter-clockwise direction, the upward movement of the valve stem 402 engaging portion 370 of the re-set lever arm 366 moves the engaging tooth portion 370 into engagement with the engaging lip 358 of the pivotable lever release 354. Additionally, valve head 404 moves the spring 388 into a compressed position. When the engaging tooth portion 370 has engaged the engaging lip 358 of the release lever 354, and the handle 366 is released, the spring 388 moves the engaging tooth portion 370 downwardly (clockwise) slightly, to pull the jaw 356 and engaging lip 358 downwardly in a clockwise direction, until such point as the engagement between the engaging lip 358 and engaging tooth portion 370 prevents further movement. In this position, as shown in FIG. 11, the flow of fluid through the interior 343 of the valve 320 is unimpeded.

If the earthquake detector 18 detects an earthquake event, or the emission detector 20, 22 detects the presence of either a burning material, or a flammable type hazardous material, a signal is sent by the respective earthquake detector 18, or emission detector 20, 22 to the control/signal generator 14. This results in a signal being generated and sent to the valve 320, that causes the solenoid 360 to actuate. This results in the lever release 346 moving in a generally counterclockwise direction, to release the engaging lip's 358 engagement with the tooth portion 370. When so released, the spring 388 acts upon the valve head 404, to move the valve head 404 into engagement between the valve seat 344, which results in the configuration shown in FIG. 12.

When this occurs, the engagement with the valve head 404 with the valve seat 344 prevents the flow of fluid through the gas/fluid shut off valve 320, thus preventing the entry of further fluid (that can be either a gaseous or liquid fluid) into the structure (or area of the structure) to which fluid is delivered by the pipe in which the shut off valve 320 resides.

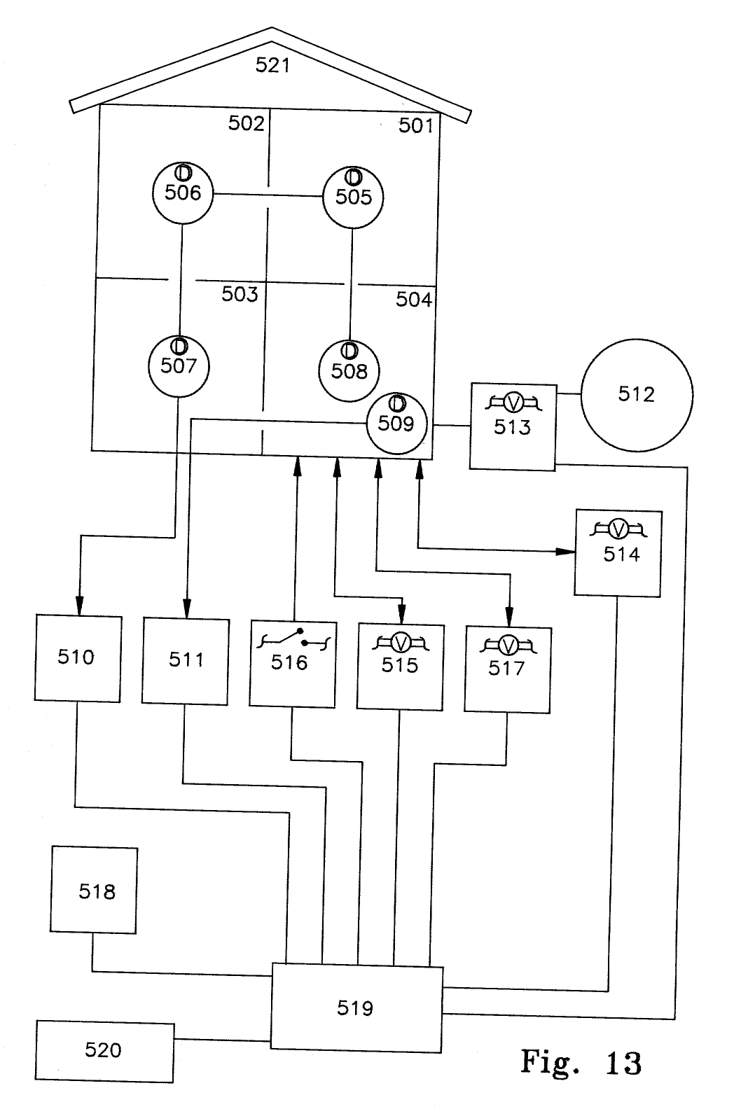

Your attention is now directed to FIG. 13, that shows an illustrative single unit, multi5 room structure, such as a house 521, wherein the earthquake/emission detector and control system of the present invention is installed. A single unit, multi-room dwelling, such as a house 521 includes four rooms, 501, 502, 503, 504. Each room includes its own separate emission detector, 505, 506, 507 and 508. These detectors may either be linked together (as shown in the drawing), or non-linked. Additionally, the residence includes a single optional hazardous emission 509.

The various emission detectors 505, 506, 507, 508 are all linked detection translator 110.

Similarly, the hazardous emission detector 509 is linked to a detection translator 511.

Each of the two detection translators 510, 511 are coupled to the control signal generator 119, that serves the same purpose as a control/signal generator 14 discussed above in connection with FIGS. 1-12. An earthquake detector 518 is also coupled to the control/signal generator 519.

A programmer display 520 is coupled to the control/signal generator 519 so that the user can program information into the control/signal generator 519. An electricity shut off valve 115, a gas shut off valve 115, a water shut off valve 117, and a waste water shut off valve 514 are each coupled to the output side of the control/signal generator 519, in a manner similar to which the corresponding components are coupled to the output side of the control/signal generator 14 of the device shown in FIG. 1.

The hazardous materials emission detector 509 may not be utilized in all residential structures, nor utilized in all commercial structures. However, the hazardous materials emission detector 509 would be a valuable addition to a system in a commercial structure wherein a hazardous material storage container 112 is utilized to deliver hazardous material into the structure 521. In such a case, the hazardous material automatic shut off valve 113 is inserted into the hazardous material delivery line, and is coupled to the output side of the control/signal generator 519, so that in the event of an earthquake, or an emission event, the flow of hazardous material from the hazardous material storage container 512 into the structure 521 is shut off.

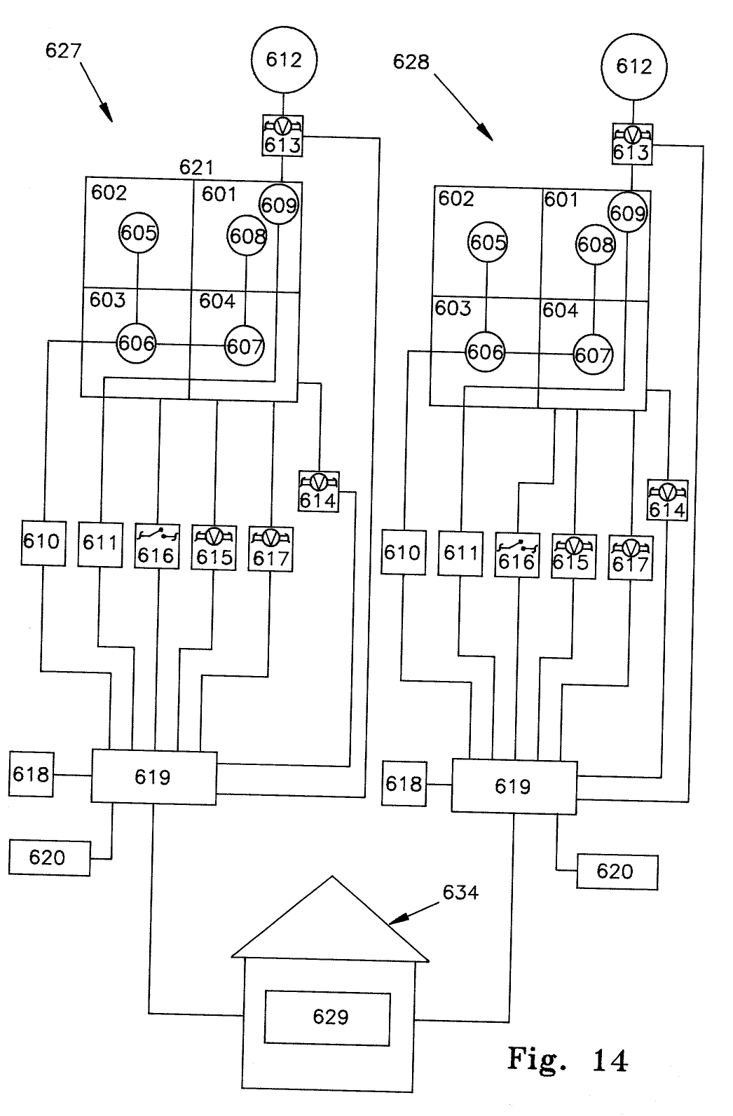

FIG. 14 shows a schematic representation (similar to FIG. 13) of the invention is used in connection with a multi-unit structure, such as one might find at an industrial complex, multi10 unit commercial building or multi-building apartment complex, or shopping center. In the illustration of FIG. 14, the invention is shown as applied to a multi-unit facility having first 627 and second 628 separate units. Of course, it will be appreciated that the system could be applied to a complex having a plurality of units.

Each of the two units are shown to virtually identical, although they need not be. Each of the first and second units 627, 628 includes a structure having four rooms 601, 602, 603, 604. An emission detector 605, 606, 607, and 608 is disposed in each of the four rooms. Additionally, a hazardous material detector 609 is disposed in one of the four areas within the structure. The emission detectors 605, 606, 607, 608 are all coupled to a detection translator 610, which itself is coupled to the control/signal generator 619, which itself is coupled to a programmer display 620. The hazardous emission detectors 609 are also coupled to detection translator 111, which itself is coupled to the control/signal generator 619. The output side of the control/signal generator 619 is coupled to the waste water automatic shut off valve 614, the gas automatic shut off valve 615, the electricity automatic shut off valve 616, and the water automatic shut off valve 617. Additionally, and optionally, a hazardous materials automatic shut off valve 613 is inserted into the delivery line between hazardous material container 612 and the structures 627 or 628, if the hazardous material is used within the facility. An earth movement detector 618 is coupled to the input side of the control/signal generator 619, in much the same way as its counterpart component in the embodiment disclosed in FIGS. 1 and 13.

The output side of each of the control/signal generators 619 is also coupled to a master control/signal generator 629 that resides at a monitoring station, such as a guard house 634, or at a remote monitoring facility operated by an alarm service company. From the central guard house/monitoring center 634, a guard can monitor the performance, emission events, and earthquakes, along with the performance of the various shut off valves for a plurality of units.

Having described the invention and referenced certain preferred embodiments, it will be appreciated that variation and modifications exist within the scope and spirit of the invention as set forth below in the appended claims.

What is claimed is:

1. An earthquake sensor and control system for sensing the presence of an earthquake event and shutting off the flow of at least one utility service in response thereto comprising
a vibration sensor for sensing vibrations caused by an earthquake,
a signal generator for generating a utility flow stop signal in response to an earthquake induced vibration sensed by the vibration sensor, and
a utility flow control capable of stopping the flow of a utility service in response to receiving the utility flow stop signal.

2. The earthquake sensor and control system of claim 1 wherein the utility service comprises an electrical utility service, and the utility flow control comprises a circuit breaker.

3. The earthquake sensor and control system of claim 1 wherein the utility service comprises the delivery of a fluid, and the utility flow control comprises a valve for shutting off the flow of fluid.

4. The earthquake sensor and control system of claim 3 wherein the fluid delivered comprises a petroleum based fluid and the valve includes a biasing device for urging the valve into a closed position in response to the reception of a signal from the signal generator.

5. The earthquake sensor and control system of claim 4 wherein the petroleum based fluid is selected from the group consisting of heating oil, natural gas, LP gas and petroleum based hazardous chemicals.

6. The earthquake sensor and control system of claim 3 wherein the fluid delivered comprises water, and the valve includes a biasing device for urging the valve into a closed position in response to the reception of a signal from the signal generator.

7. The earthquake sensor and control system of claim 1, wherein the utility flow control comprises a fluid control valve, the fluid control valve including a valve member, an engaging member for engaging the valve member to maintain the valve member in an open position to permit the flow of fluid therethrough, a trigger member for releasing the engaging member in response to receiving the flow stop signal, and a biasing device for urging the valve member into a closed position in response to the reception of the flow stop signal from the signal generator.

8. The earthquake sensor and control system of claim 1 wherein the utility flow control comprises a fluid control valve including:
a valve member disposed at least partially in a fluid flow path,
a valve seat engageable by the valve member, the engagement of the valve member with the valve seat preventing the flow of fluid through the fluid flow path,
a spring for normally biasing the valve member into engagement with the valve seat,
a valve engaging member engageable with the valve member for maintaining the valve member in a position disengaged from the valve seat to permit the flow of fluid in the fluid flow path,
a trigger member engageable with the valve engaging member, the trigger member being actuated to move the valve engaging member out of engagement with the valve member upon receipt of a utility flow stop signal,
wherein the disengagement of the valve engaging member from the valve member permits the valve member to move into engagement with the valve seat under the influence of the spring member, to thereby stop the flow of water in the fluid flow path.

9. The earthquake sensor and control system of claim 1 wherein the vibration sensor includes:
an electrically conductive liquid,
a first contact in substantially constant electrical contact with the electrically conductive liquid, and
a second contact positioned to normally be out of electrical contact with the electrically conductive liquid, but capable of becoming in electrically conductive contact with the electrically conductive liquid in response to an earthquake induced vibration, to generate a signal thereby.

10. The earthquake sensor and control system of claim 9, wherein the sensor includes a vessel for holding the electrically conductive liquid, and
the first contact is disposed within the vessel, and submerged within the electronically conductive liquid, and
the second contact is disposed above the surface of the electrically conductive liquid

11. The earthquake sensor and control system of claim 10, wherein the electrically conductive liquid comprises mercury, and
the second contact comprises a generally disc-shaped contact having a surface area greater than the surface area of the first contact, the second contact being positioned in proximity to a surface of the mercury to permit movement of the mercury under the influence of earthquake-induced vibrations to contact the second contact to thereby complete a signal generating circuit with the first contact.

12. The earthquake sensor and control system of claim 11, wherein the vessel has a generally spherical shape, and the second contact is generally ring shaped.

13. The earthquake sensor and control system of claim 1, wherein the utility service comprises an electrical utility service and the utility flow control comprise a circuit breaker, the circuit breaker including an actuable triggering mechanism for stopping the flow of electricity therethrough in response to the reception of a signal from the signal generator.

14. The earthquake sensor and control system of claim 13, wherein the circuit breaker includes a first and second contact, the first contact being moveable with respect to the second contact to move the first contact into and out of engagement with the second contact, wherein the triggering mechanism comprises a solenoid for moving the first contact out of engagement with the second contact in response to the reception of the signal from the signal generator.

15. The earthquake sensor and control system of claim 13, wherein the circuit breaker includes a first and second contact, the first contact being movable with respect to the second contact to move the first contact into and out of engagement with the second contact, wherein the triggering mechanism comprises an electromagnetic member for magnetically moving the first contact out of engagement with the second contact in response to the reception of the signal from the signal generator.

16. The earthquake sensor and control system of claim 13, wherein the circuit breaker includes a heat actuable triggering mechanism for ceasing the flow of electricity through the circuit breaker in response to the flow of amperage through the circuit breaker greater than a pre-determined value.

17. The earthquake sensor and control system of claim 1, further comprising an emission detector for detecting the presence of at least one of a burning material and a flammable material, and
a signal generator for generating a utility flow stop signal in response to the detection at least one of a smoke emitting flammable material detected by the emission detector

18. The earthquake sensor and control system of claim 17, wherein
the signal generator for generating a utility flow stop signal in response to an earthquake induced vibration and the signal generator for generating a utility flow stop signal in response to the detection of at least one of smoke and a flammable material, each include a programmable control for permitting the user to determine to which of the utility services the utility stop flow signal is sent.

19. The earthquake sensor and control system of claim 17, wherein
the signal generator for generating a utility flow stop signal in response to an earthquake induced vibration, and the signal generator for generating a utility stop signal in response to the detection of at least one of a smoke emitting and flammable material each include
a programmable controller for permitting the user to establish the level of earthquake induced vibration required to cause the signal generator to generate a utility flow stop signal in response thereto, and to establish the level of the at least one of a smoke emitting material and flammable material required to cause the signal generator to generate a utility flow stop signal in response thereto.

20. The earthquake sensor and control system of claim 17, wherein the emission detector comprises at least one of a smoke detector and a gas sniffer.

21. The earthquake sensor and control system of claim 17 wherein
the signal generator for generating a utility flow stop signal in response to an earthquake induced vibration, and the signal generator for generating a utility flow stop signal in response to the at least one of a smoke emitting and flammable material comprises a single signal generator capable of generating both signals.

22. The earthquake sensor and control system of claim 17, wherein the emission detector comprises a plurality of emission detectors communicatively coupled to the signal generator, the signal generator being capable of generating a utility flow stop signal in response to a detection by any one of the plurality of emission detectors.
